(19) United States
(12) Patent Application Publication
(10) Pub. No.: US 2024/0388499 A1
(43) Pub. Date: Nov. 21, 2024

(54) ENHANCEMENT OF MEDIA CONTENT CONSUMPTION

(71) Applicant: NAGRAVISION SARL, CHESEAUX-SUR-LAUSANNE (CH)

(72) Inventors: Jonathan Bennett-James, Treharris (GB); Craig Holbrook, Merthyr Tydfil (GB)

(73) Assignee: NAGRAVISION SARL, CHESEAUX-SUR-LAUSANNE (CH)

(21) Appl. No.: 18/665,204

(22) Filed: May 15, 2024

Related U.S. Application Data
(60) Provisional application No. 63/466,901, filed on May 16, 2023.

(51) Int. Cl. H04L 41/069; H04L 41/0806; H04L 67/75

(52) U.S. Cl. CPC H04L 41/069; H04L 41/0806; H04L 67/75

(57) ABSTRACT

Systems and techniques are provided for enhancing media content. In some examples, a network device of a network can detect a first event tag in an item of media content. The first event tag is associated with a first event in the item of media content and a first functionality of a first client device connected to the network. The first functionality corresponds to the first event in the item of media content. The network device can transmit, based on detecting the first event tag in the item of media content, a first activation message to the first client device to cause the first client device to perform the first functionality corresponding to the first event in the item of media content.

### CROSS-REFERENCE TO RELATED APPLICATIONS

The present patent application claims the priority benefit of U.S. Provisional Patent Application No. 63/466,901 filed May 16, 2023, the disclosures of which are incorporated by reference herein.

### FIELD

The present disclosure generally relates to processing media content. For example, aspects of the present disclosure relate to systems and techniques for enhancing media content.

### BACKGROUND

Media capture devices can capture various types of media content, including images, video, and/or audio. For example, a camera can capture image data or video data of a scene. The media data from a media capture device can be captured and output for processing and/or consumption. For instance, a video of a scene can be captured and processed for display on one or more viewing devices. In some cases, media content (e.g., live media content, streaming or over-the-top (OTT) media content) can be provided to a device of a user for display.

Many networks (e.g., local area networks such as home networks, shared networks, etc.) include connected devices, such as Internet-of-Things (IoT) devices. With more and more connected devices being used in such networks, there is an opportunity to make use of these devices to enhance media content, such as to make the experience of watching television content, film content, sports content, etc. more engaging.

### SUMMARY

Systems and techniques are described for enhancing media content. According to at least one illustrative example, a method of enhancing media content performed by a network device of a network includes: detecting a first event tag in an item of media content, the first event tag being associated with a first event in the item of media content and a first functionality of a first client device connected to the network, the first functionality corresponding to the first event in the item of media content; and based on detecting the first event tag in the item of media content, transmitting a first activation message to the first client device to cause the first client device to perform the first functionality corresponding to the first event in the item of media content.

In another illustrative example, a network device for enhancing media content includes at least one memory and at least one processor coupled to the at least one memory. The at least one processor is configured to: detect a first event tag in an item of media content, the first event tag being associated with a first event in the item of media content and a first functionality of a first client device connected to the network, the first functionality corresponding to the first event in the item of media content; and based on detecting the first event tag in the item of media content, transmit a first activation message to the first client device to cause the first client device to perform the first functionality corresponding to the first event in the item of media content.

In another illustrative example, a non-transitory computer-readable medium includes instructions that, when executed by at least one processor, cause the at least one processor to: detect a first event tag in an item of media content, the first event tag being associated with a first event in the item of media content and a first functionality of a first client device connected to the network, the first functionality corresponding to the first event in the item of media content; and based on detecting the first event tag in the item of media content, transmit a first activation message to the first client device to cause the first client device to perform the first functionality corresponding to the first event in the item of media content.

In another illustrative example, a method of enhancing media content performed by a server device includes: obtaining an item of media content; processing the item of media content to identify a plurality of events in the item of media content; and generating a plurality of event tags for the plurality of events, the plurality of event tags including at least a first event tag associated with a first event in the item of media content and a first functionality of a first client device connected to a network.

In another illustrative example, a server device for enhancing media content includes at least one memory and at least one processor coupled to the at least one memory. The at least one processor is configured to: obtain an item of media content; processing the item of media content to identify a plurality of events in the item of media content; and generate a plurality of event tags for the plurality of events, the plurality of event tags including at least a first event tag associated with a first event in the item of media content and a first functionality of a first client device connected to a network.

In another illustrative example, a non-transitory computer-readable medium includes instructions that, when executed by at least one processor, cause the at least one processor to: obtain an item of media content; processing the item of media content to identify a plurality of events in the item of media content; and generate a plurality of event tags for the plurality of events, the plurality of event tags including at least a first event tag associated with a first event in the item of media content and a first functionality of a first client device connected to a network.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a system including a network device in communication with a media server device via a wide area network and a plurality of client devices via a local area network, in accordance some aspects of the present disclosure.

FIG. 2 is a flow diagram of illustrating an example of process that can be performed by a server device to process media content to generate event tags for the media content, in accordance some aspects of the present disclosure.

FIG. 3 is a diagram illustrating an example of setup engine for enhancing media content, in accordance some aspects of the present disclosure.

FIG. 4 is a flow diagram illustrating an example of process performed by a setup engine for enhancing media content, in accordance some aspects of the present disclosure.

FIG. 5 is a diagram illustrating an example of a network device for enhancing media content, in accordance some aspects of the present disclosure.

FIG. 6A is a flow diagram illustrating an example of a process for enhancing media content, in accordance some aspects of the present disclosure.

FIG. 6B is a diagram illustrating an example of an environment including a network device in communication with various devices connected to a network, in accordance some aspects of the present disclosure.

FIG. 6C is a diagram illustrating an example of an environment in which a user may view media content using an extended reality device, in accordance some aspects of the present disclosure.

FIG. 6D is a diagram illustrating an example of an environment in which a user may view media content, in accordance some aspects of the present disclosure.

FIG. 7 is a flow diagram illustrating an example of process for enhancing media content, in accordance some aspects of the present disclosure.

FIG. 8 is a flow diagram illustrating an example of process for processing media content, in accordance some aspects of the present disclosure.

FIG. 9 illustrates an example computing device architecture, in accordance with some examples of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Various types of media content can be provided for consumption, including video, audio, images, among others. For example, a media content provider can provide media content to a user device for display. The media content can include live content and/or pre-recorded content. The media content can include a television broadcast (e.g., broadcast over a cable network, Satellite network, etc.), a video stream (e.g., streamed over the Internet or other communications network), an audio broadcast, an audio stream, and/or other media content.

In some cases, a network can include a number of connected devices (e.g., Internet-of-Things (IoT) devices). The network can include, for example, a local area network (e.g., a home network), a shared network (e.g., a plurality of IoT devices connected to create the shared network), or other type of network. It would be beneficial to enhance media content using such connected devices, such as to make the experience of watching television content, film content, sports content, etc. more engaging.

Systems and techniques are described herein for enhancing media content using one or more client devices connected to a network. For example, event tags can be added to media content, which can trigger a network device of a network to cause one or more client devices connected to the network to perform various functionalities or actions (e.g., output audio, output lighting with varying brightness or colors). Various aspects of the present disclosure are described in more detail below with respect to the figures.

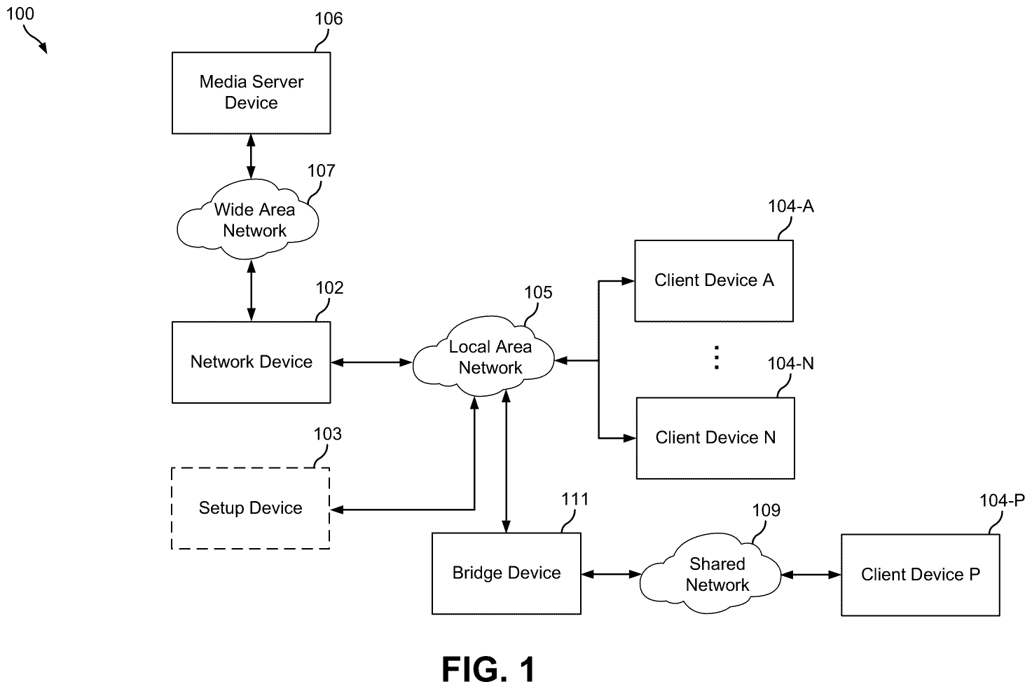

FIG. 1 is a block diagram illustrating an example of a system 100 for enhancing media content. As shown, the system 100 includes a network device 102 in communication with a media server device 106 over a wide area network 107 and in communication with one or more client devices 104-A through 104-N (with N being equal to any value equal to or greater than 0) over a local area network 105 in an environment (e.g., a house, a business, an outdoor environment, etc.). The system 100 further includes an optional (as indicated by the dashed outline) setup device 103 in communication with the one or more client devices 104-A through 104-N over the local area network.

The wide area network 107 can include the Internet in some cases. The local area network 105 can include any type of network, such as a WiFi™ network, a cellular network (e.g., an LTE/4G network, a NR/5G network, or the like), a shared network, any combination thereof, and/or other type of local network. A shared network can include a plurality of IoT devices connected together to create the shared network. For example, a group of users with IoT devices connected to different WiFi networks may gather for an event in an outdoor environment within network coverage of the WiFi networks. The users may consent to connecting their IoT devices to create the shared network for a shared experience. In some cases, the shared network may be a separate network from the local area network 105. For instance, as shown in FIG. 1, a bridge device 111 may use a portion of the Internet bandwidth provided by the local area network 105 to provide a shared network 109 for one or more client devices (e.g., a client device 104-P).

The network device 102 can include any type of network device, such as a television (e.g., a network-connected or “smart” television), a set-top box, a laptop computing device, a wearable device (e.g., a virtual reality (VR) headset, an augmented reality (AR) device such as an AR headset or AR glasses, a network-connected watch or smartwatch, or other wearable device), a router, or other network device. Each of the one or more client devices 104-A through 104-N can include any type of computing in device, such as a mobile device (e.g., a mobile phone, such as a “smart” phone), a desktop computing device, a tablet computing device, a wearable device (e.g., a VR headset, an AR device such as an AR headset or AR glasses, a network-connected watch or smartwatch, or other wearable device), and/or any other computing device with the resource capabilities to perform the processes described herein.

The media server device 106 can provide any type of media content, including video, audio, images, any combination thereof, and/or any other type of media on a variety of channels. For instance, the media server device 106 can provide video content, such as a movie, a show, and/or other type of video content on a given channel. The media content can be live or pre-recorded. In some cases, the media server device 106 can obtain the media content from a media source. The media source can include one or more media capture devices, one or more storage devices for storing media content, a system of a media service provider (e.g., a broadcast content provider, a streaming or OTT content provider, etc.), any combination thereof, and/or any other source of media content. In some cases, the media server device 106 can include one or more server computers (e.g., cloud-based servers).

The media server device 106 can process an item of media content (e.g., television content, a movie or film, etc.) to identify or determine a plurality of events in the item of media content. In some examples, the media server device 106 can use a machine learning system (e.g., using one or more neural networks or other type of machine learning system or model) to identify or determine (e.g., classify) certain actions or other events in the item of media content. In some cases, the machine learning system can determine action(s) to perform and/or which device type(s) to use for the action(s) in response to identifying a particular event in the media content. In some examples, a neural network model can be trained using supervised learning (e.g., using training videos as ground truth) to classify one or more actions as an event in one or more items of media content, to determine one or more actions to take based on a particular event, and/or to determine device types to use for the action(s). In another example, the media server device 106 can perform image analysis to determine primary colors. Illustrative examples of events that can be identified in media content include a doorbell ringing, a window breaking, light effects such as bright or dark scenes, a loud sound, a sound having an origination location a far distance from a current scene (e.g., for a scene including characters in a room of a house, a sound from outside of the house, otherwise known as an off screen event), a phone ringing, a goal, basket, touchdown, etc. being scored in a sporting event, cheering (e.g., in a sporting event), an explosions, dramatic changes to scene lighting (e.g., rapid changes from light to dark or dark to light, changing colors, etc.), among others.

Once an event is determined or identified in the item of media content, the media server device 106 can generate an event tag for the event. In some examples, when an event is detected, the media server device 106 can add one or more event tags to content data (e.g., metadata) of the item of media content. In such cases, the event tags can be transmitted to the network device 102 along with (e.g., included in) the item of media content. In other examples, the event tags can be included separately from the item of media content (e.g., in a separate file that is transmitted with the item of media content), in which case the tags can be transmitted to the network device 102 separately from the item of media content (e.g., in a file that is separate from the item of media content). In some cases, the event tag can include a time stamp, a functionality or action (e.g., play a sound such as a doorbell ringing, output lighting with varying brightness or colors, etc.), and a target device type indicating a type of client device that can perform the functionality. For example, the media server device 106 can determine that a first event includes a loud sound. The media server device 106 can associate an audio-output functionality and an audio-output-capable target device type with an event tag of the first event. The media server device 106 can also determine that a second event includes a change in lighting. The media server device 106 can associate a lighting-output functionality and a light-output-capable target device type with an event tag of the second event.

The media server device 106 can add event tags to pre-recorded content and/or to live content. For pre-recorded content, the media server device 106 can add the event tags prior to the pre-recorded content being provided to the network device 102. For live content, a content encoder (e.g., a video and/or audio encoder) can add a delay to the item of content (e.g., so that the content can be tagged with event tags prior to being processed and subsequently displayed for viewing) and scanned in real time.

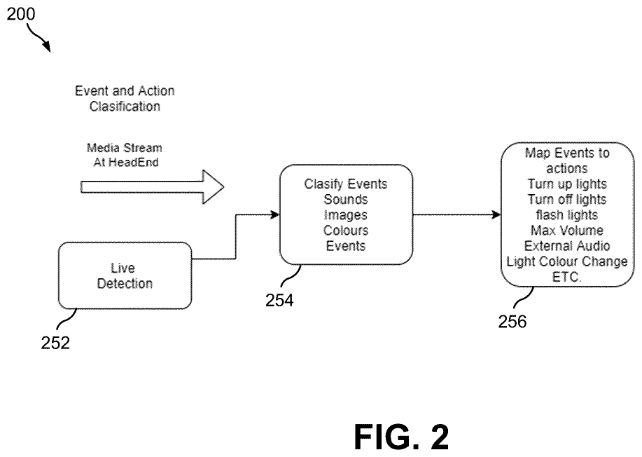

FIG. 2 is a flow diagram illustrating an example of a process 200 that can be performed by the media server device 106 to process media content to generate event tags for the media content. At block 252, the media server device 106 can perform live detection of a media stream (e.g., at a head-end of a media system). At block 254, based on performing live detection of the media stream, the media server device 106 can detect or classify the events into one or more categories, such as sounds, images, colors, events (e.g., a goal being scored, an interaction between characters, etc.). At block 256, the media server device 106 can map the detected or classified events to functionalities or actions. As shown, examples of functionalities or actions can include turning up lights (e.g., to turn on or brighten lights), turn off lights, cause lights to be output with different colors, flashing lights, cause audio to be output at a maximum volume), cause external audio to be output (e.g., audio output by a client device outside of a house or outside of a room in which the media content is being displayed), causing supplemental content to be presented (e.g., presenting a notification, displaying images or video and/or playing audio content) among others.

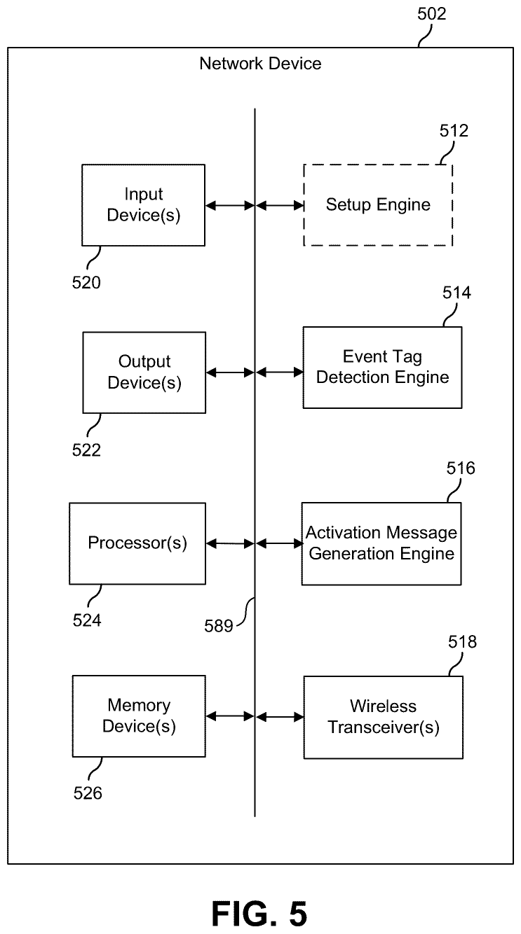

Returning to FIG. 1, the setup device 103 can include a setup engine that can be used to configure the client devices 104-A through 104-N connected to the local area network 105 to perform actions triggered by activation messages from the network device 102 (discussed in more detail below). In some cases, the setup device 103 can be a separate device from the network device 102, such as a mobile device (e.g., a mobile phone, a tablet computer, a VR headset, an AR device, etc.). In other cases, the network device 102 can include a setup engine (e.g., the setup engine 512 of FIG. 5) and can operate as the setup device, in which case a separate setup device 103 may not be needed in the system 100 of FIG. 1.

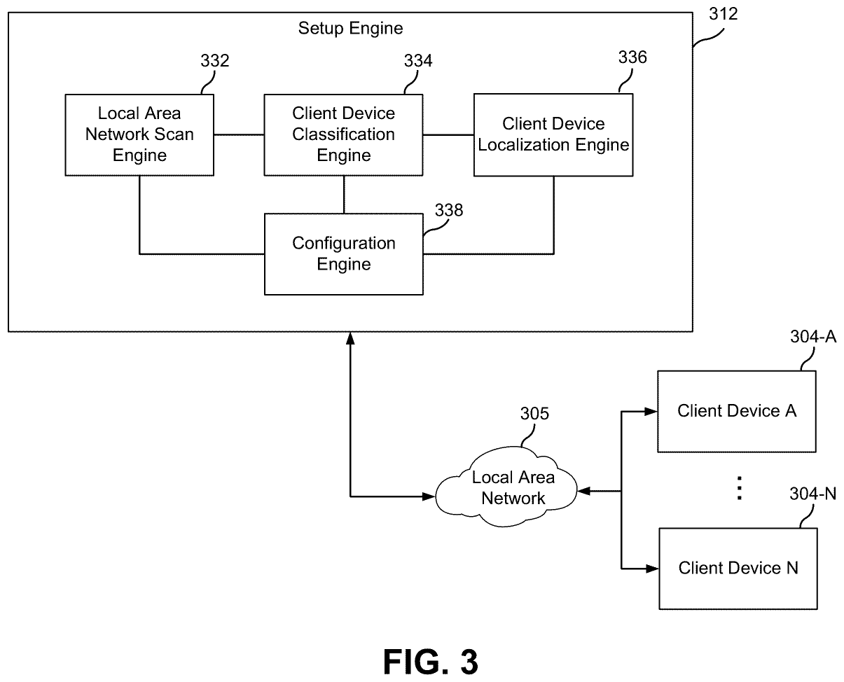

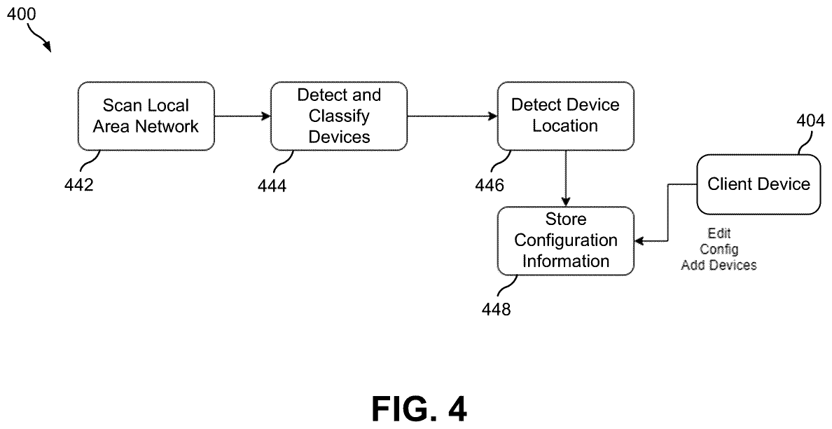

FIG. 3 is a diagram illustrating an example of a setup engine 312, which can be part of the setup device 103 and/or part of the network device 102 (e.g., the setup engine 512 of FIG. 5) discussed with respect to FIG. 1. The setup engine 312 includes a local area network scan engine 332, a client device classification engine 334, a client device localization engine 336, and a configuration engine 338. Example operations of the setup engine 312 will be described with respect to FIG. 4, which is a flow diagram illustrating an example of process 400 that can be performed by the setup engine 312. The setup engine 312 is in communication with client devices 304-A through 304-N, which in some cases can be the same as the client devices 104-A through 104-N of FIG. 1.

At block 442, the local area network scan engine 332 can scan a local area network 305 for client devices 304-A through 304-N connected to the local area network. The local area network 305 can be similar to or the same as the local area network 105 or the shared network 109 of FIG. 1. For example, the local area network scan engine 332 can broadcast a message that can be received by any client device connected to the local area network 305. The client devices 304-A through 304-N connected to the local area network 305 can respond by transmitting a response message that can be received by the setup device and/or network device and provided to the setup engine 312. In some cases, a response message from a client device, such as client device 404, can include information associated with the client device. In some examples, the information can include a device type of the client device (e.g., audio-output-capable target device type, light-output-capable target device type, image/video-output capable device type, video-rendering capable device, notification-output capable device, etc.). Additionally or alternatively, the information can include functionalities or actions supported by the client device (e.g., audio-output functionality, lighting-output functionality, image/video-output functionality, video-rendering functionality, notification-output functionality, etc.). Additionally or alternatively, the information can include a location of the client device. In some aspects, the location may be relative to a map of an environment (e.g., a map of a home). As such the location may indicate a room in which the client device is located. Additionally or alternatively, the location may be relative, for example, to another device (e.g., network device 102). As such the location may indicate a location as measured in distance from the main display device or relative to the local area network scan engine 332, a network device 102, and/or other devices, and/or other location. In some cases, the location of the client device (e.g., a location relative to a map, a location in a home, or a distance from the main display device, a room in which the client device is located, etc.) can be stored in the client devices 304-A through 304-N when the client devices 304-A through 304-N were set up in the local area network.

At block 444, the client device classification engine 334 can detect and classify the 304-A through 304-N connected to the local area network 305. For instance, the client device classification engine 334 can determine a respective device type and/or functionality (or action capability) associated with each client device. At block 446, the client device localization engine 336 can detect a location of the 304-A through 304-N connected to the local area network 305. In one illustrative example, setup device 103 and/or network device 102 can transmit a setup activation message to some or all of the client devices 304-A through 304-N connected to the local area network 305. The setup activation message can cause the client devices 304-A through 304-N to perform a functionality or action, such as play a sound, turn on and off lights, vibrate, present a notification, display an image, play a video, and/or other functionality for an associated duration of time. The setup device 103 and/or network device 102 can include one or more sensors for capturing sensor data representing the functionality or action. Illustrative examples of sensors include a camera for capturing images of the client devices 304-A through 304-N performing the action (e.g., turning on and off lights), a microphone for capturing sounds output by the client devices 304-A through 304-N, range sensors (e.g., light-detection and ranging (LIDAR) sensors, radar sensors, etc.) for determining distances of the client devices 304-A through 304-N from the main display device, network device, and/or setup device, among others. Based on the sensor data, the client device classification engine 334 can determine a respective device type and/or functionality (or action capability) associated with each client device and the client device localization engine 336 can determine locations of the devices in the environment (e.g., a house), among other information.

In one illustrative example, while configuring a client device, the setup engine 312 of the setup device 103 and/or the network device 102 can transmit a setup activation message to the client device. The setup activation message can cause the client device to output a range of audio tones (e.g., via one or more speakers of the client device). The setup engine 312 can detect the audio tones (e.g., via one or more microphones of the network device 102 and/or the setup device 103). Using the detected audio tones, the setup engine 312 can calculate a distance and/or a direction of the client device away from the main display device (and/or the network device 102 or setup device 103). In one illustrative example, the distance and/or direction can be determined using spatial perception techniques. In some cases, the network device 102 and/or the setup device 103 can store the distance and/or direction, which can provide a reference of which client device(s) are at particular distances and/or directions relative to the main display device.

In another illustrative example, while configuring a client device, the setup engine 312 of the setup device 103 and/or the network device 102 can transmit a setup activation message to the client device. The setup activation message can cause the client device to output a range of colors (e.g., using one or more light-output devices, such light-emitting diodes (LEDs) or other light source), such as in different colors, different brightness levels, etc. The setup engine 312 can detect the light output from the client device. Based on the detected light, the setup engine 312 can determine light-based capabilities of the client device, such as whether the client device has the capability to increase or decrease brightness of light, whether the client device can display different colors of light, and/or whether the client device is visible from the location of the user and/or main display device. In some cases, the network device 102 and/or the setup device 103 can store the light-based capability of the client device, which can provide a reference of which client device(s) have different light-based capabilities.

At block 448, the configuration engine 338 can generate and store configuration information for each client device of the client devices 304-A through 304-N. For instance, configuration information for the client device 404 can include one or more target device types for the client device 404 and a location of the client device 404 in the environment. In some cases, the setup device can maintain a list of client devices 304-A through 304-N and their respective configuration information. As described in more detail below, the locations of the client devices 304-A through 304-N can be used by the network device 102 to determine which client device(s) to send an activation message (e.g., for sounds that are far distances from a current scene, such as from outside of a room in which a scene in the media content is occurring, an activation message to play a sound may be transmitted to client device(s) in a different room from which the media content is being displayed). In some cases, a user can provide input via a user interface of the client device 404 to edit the configuration information including options to disable the use of a particular client device (e.g., a baby monitor) or particular event types (e.g., disable events associated with strobing lights). There may be further options provided on a network connected device to disable its usage as a client device in an environment (e.g., a user's phone may be presented with a menu to accept or reject its usage while an item of media content is played).

Returning to FIG. 1, the network device 102 can receive a media content from the media server device 106. As described in more detail below, the network device 502 can monitor the content data (e.g., metadata) of the item of media content for event tags. FIG. 5 is a diagram illustrating a network device 502, which is an example of the network device 102 of FIG. 1. As noted previously, the network device 502 can be a television (e.g., a network-connected or “smart” television), a set-top box, a laptop computing device, a VR headset, an AR device, a router, or other network device. The network device 502 may include software and/or hardware components that may be electrically or communicatively coupled via a bus 589 (e.g., or may otherwise be in communication). For example, the network device 502 includes one or more processors 524. The one or more processors 524 may include one or more central processing units (CPUs), digital signal processors (DSPs), application-specific integrated circuits (ASICs), field programmable gate arrays (FPGAs), graphics processing units (GPUs), vision processing units (VPUs), neural processing units (NSPs), microcontrollers, dedicated hardware, any combination thereof, and/or other processing device or system. The bus 589 may be used by the one or more processors 524 to communicate between cores and/or with the one or more memory devices 526. The network device 502 may also include one or more wireless transceivers 518, one or more antenna(es) (not shown), one or more input devices 520 (e.g., a camera, a mouse, a keyboard, a touch sensitive screen, a touch pad, a keypad, a microphone, a controller, and/or the like), and one or more output devices 522 (e.g., a display, paired stereoscopic displays (e.g., of a VR headset), a transparent display (e.g., of an AR headset), a speaker, earphones, a printer, and/or the like).

In some aspects, network device 502 may include one or more radio frequency (RF) interfaces (not shown) configured to transmit and/or receive RF signals. In some examples, an RF interface may include components such as wireless transceiver(s) 518, modem(s) (not shown), and/or antennas (not shown). The one or more wireless transceivers 518 may transmit and receive wireless signals via antenna(s) over a local area network (e.g., local area network 105, shared network 109, or other local area network etc.) and/or wide area network (e.g., wide area network 107) to/from one or more other devices, such as media server device 106, client devices 104-A through 104-N, the setup device 103, and/or other devices. In some examples, the network device 502 may include multiple antennas or an antenna array that may facilitate simultaneous transmit and receive functionality. One or more of the antenna(es) may be an omnidirectional antenna such that radio frequency (RF) signals may be received from and transmitted in all directions. Additionally or alternatively, one or more of the antenna(es) may be directional such that the antenna(es) may be used in localizing client devices (e.g., as described with regards to FIG. 4.

The network device 502 may also include (and/or be in communication with) one or more non-transitory machine-readable storage media or storage devices (e.g., one or more memory devices 526), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like. In various aspects, functions may be stored as one or more computer-program products (e.g., instructions or code) in memory device(s) 526 and executed by the one or more processor(s) 524. The network device 502 may also include software elements (e.g., located within the one or more memory devices 526), including, for example, an operating system, device drivers, executable libraries, and/or other code, such as one or more application programs, which may comprise computer programs implementing the functions provided by various aspects, and/or may be designed to implement methods and/or configure systems, as described herein.

The network device 502 further includes an optional setup engine 512 (described with respect to FIG. 1-FIG. 4), an event tag detection engine 514, and an activation message generation engine 516. The network device 502 can monitor the content data (e.g., metadata) of the item of media content for event tags using the event tag detection engine 514. In some cases, the event tag detection engine 514 can use the time stamps to determine when an event tag is going to occur (e.g., a time stap can indicate a time at which an event tag will occur in the media content). When an event tag is detected by the event tag detection engine 514 (e.g., based on a time stamp associated with that event tag), the event tag detection engine 514 and/or the activation message generation engine 516 can retrieve the stored configuration information of the various client devices 104-A through 104-N connected to the local area network 105.

The activation message generation engine 516 can output an activation message for transmission (e.g., via the wireless transceiver 518) to one or more of the client devices 104-A through 104-N having a particular target device type indicated in the event tag and/or in a location indicated by the event tag (e.g., a close client device, a client device at least 5 meters away from the network device 502 and/or a device displaying the media content, etc.). For instance, once a time associated with a time stamp for the event tag occurs, the network device 502 can transmit the activation message to the one or more client devices 104-A through 104-N having the particular target device type and/or in the location indicated by the event tag.

In some cases, an activation message can include information indicating to a client device the type of functionality or action to perform (e.g., turn on a light, turn on a light with a particular color and brightness, output a particular sound, output a sound with a particular volume, present a notification, display an image, play a video, etc.). Once a client device receives the activation message, the activation message can cause the client device of the target device type to perform a functionality or action indicated in the activation message in synchronization with the content being viewed. In one illustrative example, if an event in a scene includes a window breaking, the event tag detection engine 514 can detect an event tag for the event and the activation message generation engine 516 can output one or more activation messages for transmission to one or more client devices connected to the local area network. Upon receiving the activation message(s), the client device(s) can output (e.g., via one or more speakers of the client device(s)) audio described by the information in the activation message(s) in synchronization with the event in the item of media content.

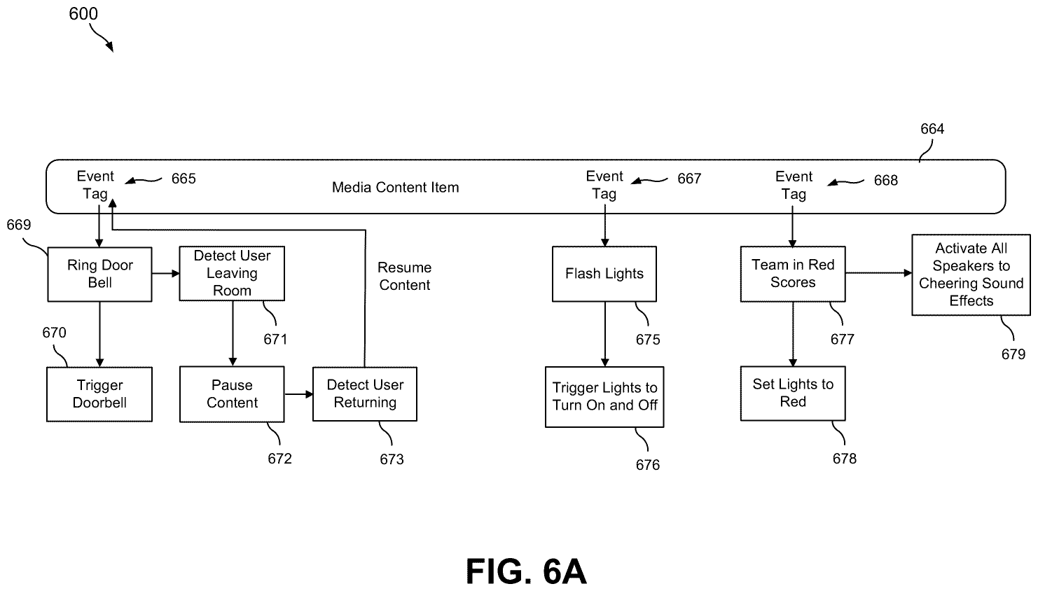

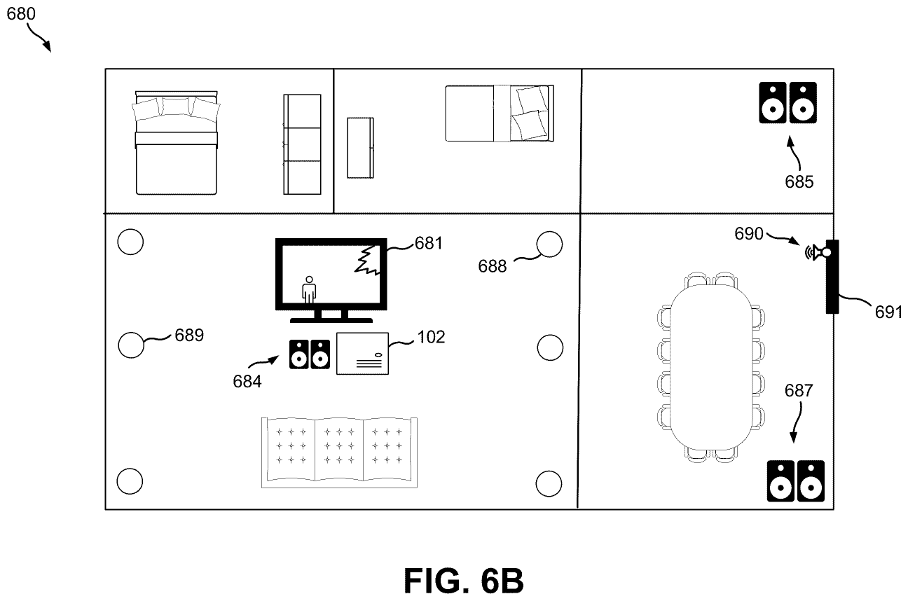

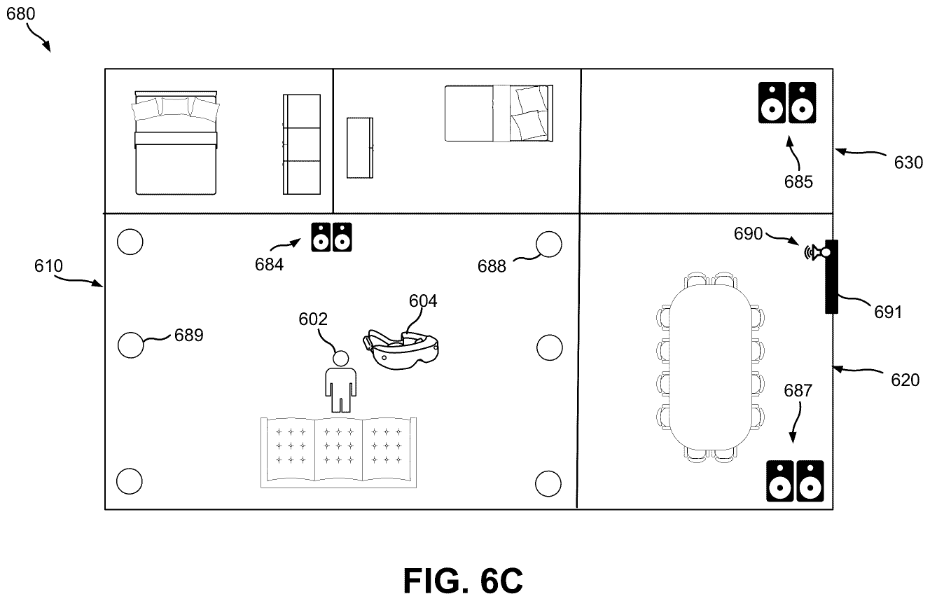

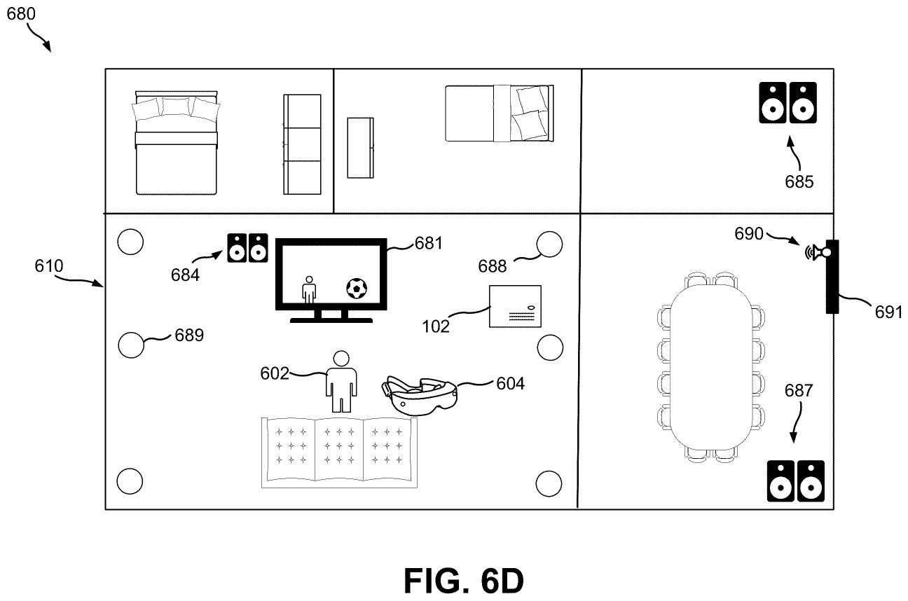

FIG. 6A is a flow diagram illustrating an example of a process 600 that can be performed by the network device 102 for enhancing media content. The process 600 of FIG. 6A will be described with respect to FIG. 6B, which is a diagram of illustrating an example of an environment 680 including a network device in communication with various devices connected to a network. As shown in FIG. 6A, a media content item 664 includes event tags, including an event tag 665, an event tag 667, and an event tag 668.

At block 669, the network device 102 can detect the event tag 665 (e.g., using the event tag detection engine 514 of FIG. 5) and determine (e.g., from the metadata associated with the event tag 665) that the event tag 665 is associated with a doorbell ringing. At block 670, the network device 102 can send an activation message to trigger or cause a connected doorbell to ring in synchronization with the doorbell ringing in the media content item 664. In one illustrative example, referring to FIG. 6B, a horror movie being presented on a main display device 681 (e.g., a television or other display device) can have an event tag associated with a doorbell ringing. The network device 102 can send an activation message to cause a connected doorbell 690 in the environment 680 to ring at the same time as the doorbell ringing in the movie.

At block 671, based on detecting the event tag 665 in the media content item 664 corresponding to the doorbell ringing, the network device 102 can detect a user (e.g., a viewer of the media content item 664) leaving the room in which the main display device 681 is located in the environment 680 of FIG. 6B. For example, the user can leave the room to open the front door 691. In some cases, the network device 102 can transmit a message to a device of the user (e.g., a mobile device), causing the device to display a notification prompting the user to open the front door 691. In one example, the user can be wearing an AR device and the AR device can display a notification prompting the user to answer the front door 691. For example, AR device may be a client device (e.g., a client device 104) and may display a notification based on detecting the event tag 665 in the media content item 664. Upon detecting the user leaving the room at block 671, the network device can pause the media content item at block 672. In some cases, when the user begins leaving the room, the network device 102 can pause the movie. When the user opens the door, the AR device can display a character from the media content item 664 outside of the viewer's home (e.g., as a hologram) and can output audio of the character (e.g., as if the character is speaking to the user). For example, AR device may be a client device (e.g., a client device 104) and may display a images and/or video of the character based on detecting the event tag 665 in the media content item 664.

At block 673, the network device can detect the user returning to the room in which the main display device 681 is located, and can automatically resume the media content item 664. In some aspects, the AR device may display the character from the media content in the room. For example, in some aspects, if the user invites the character in, the AR device may render the character in the room with the user.

At block 675, the network device 102 can detect the event tag 667 (e.g., using the event tag detection engine 514 of FIG. 5) and determine (e.g., from the metadata associated with the event tag 667) that the event tag 667 is associated with flashing lights. At block 676, the network device 102 can send an activation message to trigger or cause one or more connected lights to turn on and off in synchronization with the flashing lights in the media content item 664. In one illustrative example, referring to FIG. 6B, the network device 102 can send an activation message to cause connected lights 688 and 689 in the environment 680 to turn on and off at the same time as the flashing lights in the media content item 664.

At block 677, the network device 102 can detect the event tag 668 (e.g., using the event tag detection engine 514 of FIG. 5) and determine (e.g., from the metadata associated with the event tag 668) that the event tag 668 is associated with a sports team scoring a goal and a crowd cheering. The sports team has team colors of red (e.g., a jersey of the team is of a red color). At block 678, the network device 102 can send an activation message to trigger or cause one or more connected lights to turn red (or flash on and off with a red color) in synchronization with the goal being scored in the media content item 664 and in some cases for a period of time (e.g., 30 seconds, 1 minute, etc.) after the goal is scored. In one illustrative example, referring to FIG. 6B, the network device 102 can send an activation message to cause connected lights 688 and 689 in the environment 680 to periodically turn on and off in a red color at the same time as (and in some cases for a period of time after) after the goal is scored in the media content item 664.

At block 679, based on detecting the event tag 668 in the media content item 664 corresponding to the goal being scored and the crowd cheering, the network device 102 can send an activation message one or more connected speakers (or devices with speakers) to cause the speakers to output audio with cheering sound effects in synchronization with the goal being scored in the media content item 664. In one illustrative example, referring to FIG. 6B, the network device 102 can send an activation message to cause connected speakers 684, 685, and 687 in the environment 680 to output cheering sound effects at the same time as (and in some cases for a period of time after) after the goal is scored in the media content item 664.

The network device 102 can send various other activation messages. For instance, in another illustrative example, when an event tag associated with a loud noise (e.g., a window breaking) that is off screen (corresponding to a sound associated with a person or object that is not currently displayed) is detected, the network device 102 can send an activation message to cause a client device located in a different room from the network device 102 to output audio mimicking the loud sound (e.g., the window breaking). In yet another example, the network device can detect an event tag associated with a scene of the media content item transitioning from light to dark, and in response can send an activation message to cause client devices such as network-connected light bulbs in the room with the main display device 681 to output light in synchronization with the lighting changes in the scene (e.g., by outputting lighting with changing illuminance, color, etc.). In another example, in response to detecting an event tag corresponding to a character in the media content item participating in a phone call, the network device 102 can cause a home assistant device to output a ringing tone (e.g., mimicking a phone ringing), prompting a viewer of the movie to answer. The media content item may optionally proceed to the next scene after a predetermined duration of time or only once the user has interacted with the scene and answered the call. In some cases, the network device 102 can transmit a message to a device of the user (e.g., a mobile device), causing the device to display a notification prompting the user to answer the call. Once the user answers (e.g., by instructing the home assistant device to answer the call), the network device 102 can cause a speaker of the home assistant device to output a voice of an off-screen character from the movie.

As noted previously, network device 102 may be a VR headset or AR device. In other words, a VR headset or AR device may implement operations described herein with regard to network device 102. The term “extended reality” (XR) may include virtual reality (VR), augmented reality (AR) and/or mixed reality (MR). In the present disclosure, the term “XR device” may refer to a VR, AR, and/or MR device, such as a headset, glasses, or other head-mounted display. Network device 102 may be an XR device. In such cases, a user may view media content using the XR device and the XR device may be the “main display device.” As a main display device, an XR device may be mobile. For example, a user may wear the XR device and move through an environment.

FIG. 6C, is a diagram illustrating an example environment 680 including example rooms (e.g., room 610, room 620, and room 630). A user 602 may watch media content using an XR device 604. Initially, user 602 may watch media content in room 610. Later, user 602 may move into room 620 and continue watching the media content in room 620.

XR device 604 may determine information regarding client devices. For example, XR device 604 may perform one or more of the steps of process 400 of FIG. 4 to determine locations, relative locations, capabilities, types, and/or functionalities of various client devices of environment 680. As such, XR device 604 may implement setup engine 312 of FIG. 3 and perform operations described with regard to setup engine 312 of FIG. 3. XR device 604 may determine locations of various devices within a map of environment 680. Additionally or alternatively, XR device 604 may determine associations between client devices and rooms. Additionally or alternatively, XR device 604 may determine locations of various client devices relative to XR device 604.

In any case, XR device 604 may determine information regarding client devices such that XR device 604 may implement the operations and processes related to displaying media content described herein at XR device 604 wherever user 602 is in environment 680. For example, while user 602 is viewing media content in room 610, XR device 604 may determine that user 602 is in room 610 and/or that connected speakers 684, connected lights 688, and/or connected lights 689 are proximate to (e.g., within a threshold distance from) XR device 604. XR device 604 may determine the location and/or proximity using any of the techniques described above with regard to process 400 of FIG. 4 and/or setup engine 312 of FIG. 3.

While in room 610, XR device 604 may receive an event tag associated with close or proximate client devices (e.g., an event tag related to causing nearby speakers to play a sound and and/or nearby lights to flash). Responsive to the event tag and based on the information regarding client devices, XR device 604 may send activation messages to client devices in or associated with room 610, and/or to client devices within the threshold proximity of XR device 604. For example, responsive to an event tag related to nearby client devices, XR device 604 may send activation messages to connected speakers 684, connected lights 689, and/or connected lights 688.

Additionally or alternatively, while in room 610, XR device 604 may receive an event tag associated with distant client devices (e.g., an event tag related to causing a distant speaker to play a sound). Responsive to the event tag and based on the information regarding client devices, XR device 604 may send activation messages to client devices in or associated with room 620 and/or room 630, and/or to client devices outside the threshold proximity of XR device 604. For example, responsive to an event tag related to distant client devices, XR device 604 may send activation messages to connected speakers 687 and connected speakers 685.

Later, user 602 may move to room 620 and continue viewing media content using XR device 604. XR device 604 may track a location of XR device 604 and determine that XR device 604 is in room 620. Additionally or alternatively, XR device 604 may repeat one or more steps of process 400 of FIG. 4 and determine or update the information regarding client devices. In some aspects, XR device 604 may repeat process 400 at intervals. Additionally or alternatively. XR device 604 may repeat process 400 based on detecting that user 602 is moving. In any case, XR device 604 may determine that XR device 604 is close to connected speakers 687 and not close to connected speakers 684, connected lights 688, connected lights 689, and connected speakers 685. Then, when event tags related to close speakers and/or lights are received. XR device 604 may send activations to connected speakers 687 and when event tags related to distant speakers and/or lights are received. XR device 604 may send activations to connected speakers 684, connected speakers 685, connected lights 688, and/or connected lights 689.

XR device 604 may determine information regarding client devices and location information regarding XR device 604. XR device 604 may determine close and distant client devices. Additionally or alternatively, XR device 604 may determine room associations, directionality, and/or proximity information regarding client devices. Responsive to event tags. XR device 604 may send activations to client devices based on the location information, the room associations, the directionality information, and/or the proximity information. In this way, XR device 604 may provide user 602 with an immersive experience related to media content displayed at XR device 604 even if user 602 moves through environment 680.

As noted previously, client devices 104 may include a VR headset or AR device. In other words, a VR headset or AR device may implement operations described herein with regard to client device 104. An XR device, such as XR device 604 of FIG. 6C may perform operations based on receiving an activation responsive to an event tag and performing one or more operations based on the received activation.

FIG. 6D is a diagram illustrating an example environment 680 in which a user 602 may view media content. User 602 may view media content through XR device 604. For example, the media content may be displayed at one or more displays of XR device 604. In some aspects, the media content may be displayed as if the media content may be anchored to a surface (e.g., a wall) of room 610. For example, if user 602 turned his or her head, the view of user 602 of the media content would change. In some aspects, the media content may be projected at a constant location within a field of view of user 602. For example, if user 602 turned his or her head, the media content may be displayed in the same location of the field of view of user 602 despite user 602 turning his or her head.

Additionally or alternatively, main display device 681 may display the media content. For example, main display device 681 may be a display in room 610 that may display the media content and user 602 may view main display device 681 through XR device 604. In some aspects, XR device 604 may include a transparent display such that user 602 may view main display device 681 through XR device 604. In other aspects, XR device 604 may implement a video-see-through (VST) technique wherein XR device 604 captures video of room 610 (including main display device 681) and displays the video to user 602 at displays of XR device 604.

In any case, XR device 604 may display images, display video, and/or play audio to user 602 responsive to activations based on event tags in the media content. For example, network device 102 may provide XR device 604 (and/or main display device 681) with the media content. The media content may include tags. The tags may indicate activations to be performed by XR device 604. For example, XR device 604 may be of a XR-device type for which tags and activations are generated. Network device 102 may send an activation to XR device 604 based on the event tag and XR device 604 may display images, display video, and/or play audio responsive to the activation.

For example, user 602 may be watching a football match (on XR device 604 and/or main display device 681). A player in the football match (e.g., Mo Salah) may score a goal. Network device 102 may determine an event tag based on Mo Salah scoring. The event tag may be related to XR devices. Network device 102 may send an activation to XR device 604 based on the event tag. XR device 604 may receive the activation and may display images, display video data, and/or play audio based on the activation.

For instance, based on the activation, XR device 604 may display an images or video of fireworks (e.g., red fireworks). Additionally or alternatively, XR device 604 may play audio indicating a score of the match and/or a name of a player that scored the goal.

As another example, XR device 604 may display video of Mo Salah sliding in celebration. XR device 604 may render the video data based on room 610 and a position of XR device 604 to anchor the video data to room 610. For instance, XR device 604 may render and display Mo Salah sliding into room 610 in the field of view of user 602. Additionally or alternatively, XR device 604 may play audio data, for example, Mo Salah saying “great pass user 602!”

Additionally, network device 102 may send activations to connected lights 688 and connected lights 689 causing connected lights 688 and connected lights 689 to turn red. Additionally or alternatively, network device 102 may send activations to connected speakers 685, connected speakers 687, and/or connected speakers 684, causing connected speakers 685, connected speakers 687, and/or connected speakers 684 to play audio, for example, sounds of a crowd cheering.

In all cases, event tags and/or activations may be based on settings of user 602. For example, user 602 may be a fan of Liverpool football club. As such, event tags and/or activations may be different depending on whether Liverpool or an opponent of Liverpool scores. For example, if Liverpool scores, network device 102 may generate activations for red lights and a crowd cheering. Additionally, if an opponent scores on Liverpool, network device 102 may generate activations causing for displaying a score at XR device 604 without a crowd cheering and without a player celebration.

The video data (e.g., of Mo Salah sliding) and the audio data may or may not be based on the current frames of the media content. For example, the media content may, or may not, include audio of a crowd cheering and video content of Mo Salah sliding. The audio and video content may be predetermined. For example, the audio content (e.g., the crowd cheering and/or chanting) may be pre-recorded. The video of Mo Salah sliding may be rendered based on a pre-determined model of Mo Salah and a pre-determined set of actions (e.g., the slide). XR device 604 may render the video data and anchor the video data to room 610, for example, such that Mo Salah appears to be sliding on the floor of room 610 even if user 602 is moving (e.g., turning his or her head).

While displaying video data responsive to activations, XR device 604 may, or may not, continue to play the media data. For example, based on some activations, XR device 604 may pause playing the media content while displaying video data. In other cases, XR device 604 may continue to play the media content (e.g., anchored to a wall of room 610) while playing the video (e.g., anchored to a floor of room 610).

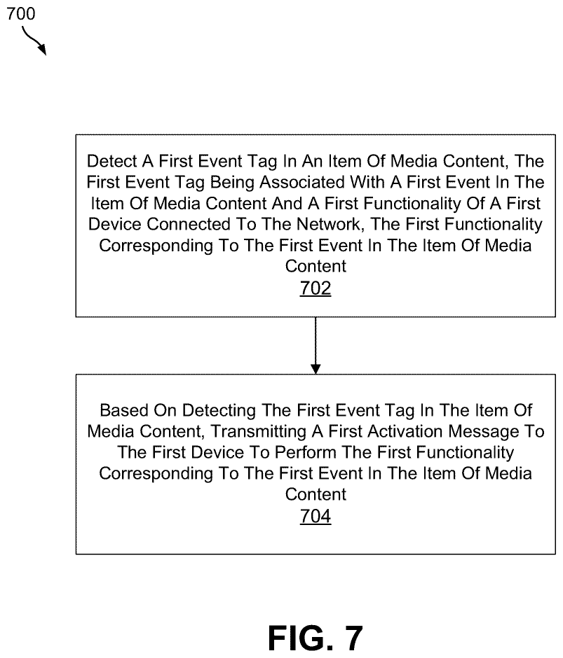

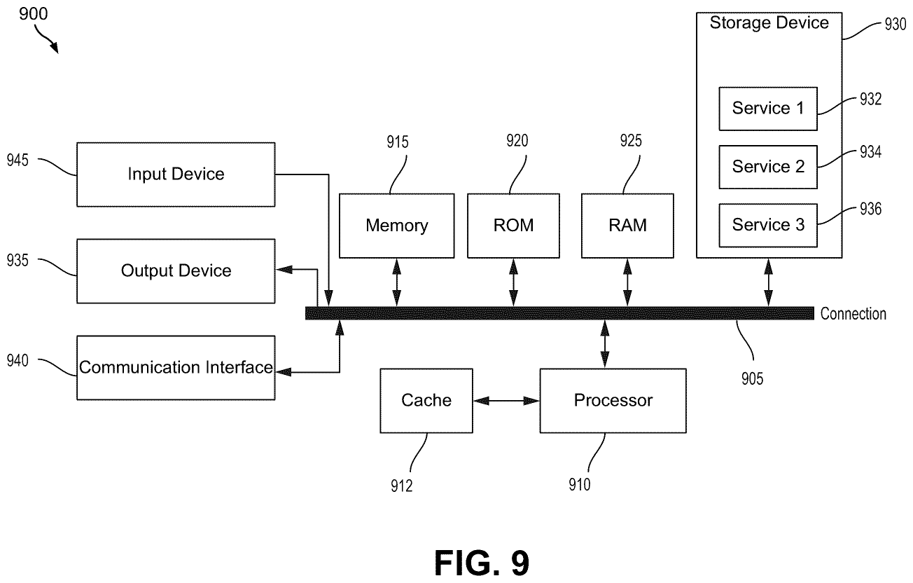

FIG. 7 is a flow chart illustrating an example of a process 700 for enhancing media content. The process 700 can be performed by a network device, or by a component or system (e.g., a chipset) of the network device. In one illustrative example, the process 700 can be performed by the network device 102 of FIG. 1, the network device 502 of FIG. 5, and/or one or more computing devices with the computing device architecture 900 shown in FIG. 9. The operations of the process 700 may be implemented as software components that are executed and run on one or more processors (e.g., processor 910 of FIG. 9 or other processor(s)).

At block 702, the network device (or component thereof) can detect a first event tag in an item of media content. The item of media content can include pre-recorded content, live content, and/or other type of content. The first event tag is associated with a first event in the item of media content and a first functionality of a first client device connected to the network. The first functionality corresponds to the first event in the item of media content. In some cases, the first event tag corresponds to a time stamp within the item of media content.

At block 704, the network device (or component thereof) can transmit, based on detecting the first event tag in the item of media content, a first activation message to the first client device to cause the first client device to perform the first functionality corresponding to the first event in the item of media content. In some examples, the first event in the item of media content includes an audio event associated with the item of media content, a lighting event associated with the item of media content, an image event associated with the item of media content, a pre-recorded video event associated with the item of media content, or a rendered video event associated with the item of media content and/or an other event. In such examples, the first functionality of the first client device can include an audio output functionality corresponding to the audio event associated with the item of media content, a light output functionality corresponding to the lighting event associated with the item of media content, an image-output functionality corresponding to the image event, a video-output functionality corresponding to the pre-recorded video event, or a rendering functionality corresponding to the rendered video event and/or other functionality.

In some examples, the network device (or component thereof) can detect a plurality of client devices connected to the network, the plurality of client devices including the first client device. The network device (or component thereof) can determine a respective location of each client device of the plurality of client devices in an environment. The network device (or component thereof) can generate configuration information for each client device of the plurality of client devices. For instance, the configuration information can include one or more target device types and the respective location of each client device of the plurality of client devices. The network device (or component thereof) can store the configuration information.

In some aspects, the network device (or component thereof) may determine respective locations of client devices multiple times. For example, the network device (or component thereof) may be an XR device and may move within the environment. The network device (or component thereof) may determine relative locations of the client devices repeatedly and/or in response to the network device (or component thereof) moving within the environment.

In some cases, the network device (or component thereof) can classify the plurality of client devices into the one or more target device types. In one illustrative example, the first event tag includes an indication of a first target device type of the one or more target device types. In such an example, the network device (or component thereof) can transmit the first activation message to the first client device further based on the indication of the first target device type in the first event tag. In some aspects, the network device (or component thereof) can determine, based on the stored configuration information, that the first client device is classified as the first target device type, and can transmit the first activation message to the first client device further based on the indication of the first target device type in the first event tag and determining that the first client device is classified as the first target device type.

In some aspects, the network device (or component thereof) can detect a second event tag in the item of media content. In one illustrative example, the second event tag can be associated with the first event in the item of media content and a second functionality of a second client device connected to the network, where the second functionality of the second client device corresponds to the first event in the item of media content. The network device (or component thereof) can, based on detecting the second event tag in the item of media content, transmit a second activation message to the second client device to cause the second client device to perform the second functionality corresponding to the first event in the item of media content. In another illustrative example, the second event tag can be associated with a second event in the item of media content and a second functionality of a second client device connected to the network, where the second functionality of the second client device correspond to the second event in the item of media content. The network device (or component thereof) can, based on detecting the second event tag in the item of media content, transmit a second activation message to the second client device to cause the second client device to perform the second functionality corresponding to the second event in the item of media content. In such examples, the plurality of client devices connected to the network include the first client device and the second client device.

In some cases, the second event tag includes an indication of a second target device type of the one or more target device types. In such cases, the network device (or component thereof) can determine, based on the stored configuration information, that the second client device is classified as the second target device type. The network device (or component thereof) can transmit the second activation message to the second client device further based on the indication of the second target device type in the second event tag and determining that the second client device is classified as the second target device type.

In some examples, the network device (or component thereof) can transmit the first activation message to the first client device further based on a location of the first client device in an environment and a characteristic of the first event in the item of media content. For instance, the characteristic of the first event in the item of media content may include a volume of audio associated with the first event, an origination location (e.g., an off screen location) of the audio associated with the first event, and/or other characteristic.

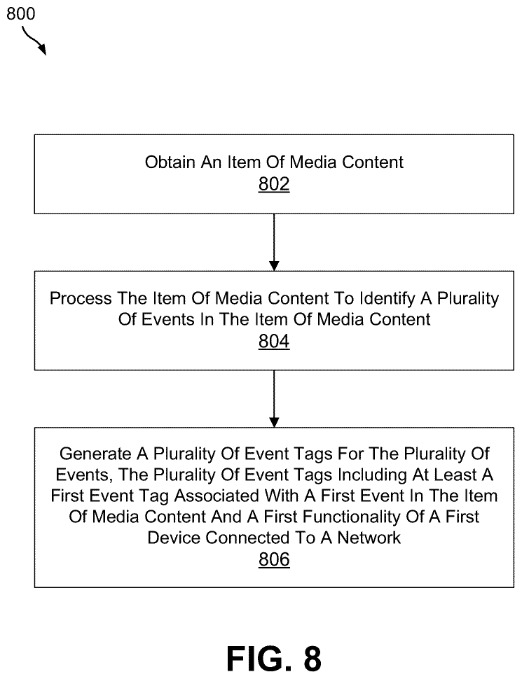

FIG. 8 is a flow chart illustrating an example of a process 800 for enhancing media content. The process 800 can be performed by a server device, or by a component or system (e.g., a chipset) of the server device. In one illustrative example, the process 800 can be performed by the media server device 106 of FIG. 1 and/or one or more computing devices with the computing device architecture 900 shown in FIG. 9. The operations of the process 800 may be implemented as software components that are executed and run on one or more processors (e.g., processor 910 of FIG. 9 or other processor(s)).

At block 802, the server device (or component thereof) can obtain an item of media content. The item of media content can include pre-recorded content, live content, and/or other type of content.

At block 804, the server device (or component thereof) can process the item of media content to identify a plurality of events in the item of media content. At block 806, the server device (or component thereof) can generate a plurality of event tags for the plurality of events. The plurality of event tags include at least a first event tag associated with a first event in the item of media content and a first functionality of a first client device connected to a network. In some examples, the first event in the item of media content includes an audio event associated with the item of media content, a lighting event associated with the item of media content, an image event associated with the item of media content, a pre-recorded video event associated with the item of media content, or a rendered video event associated with the item of media content and/or another event. In such examples, the first functionality of the first client device can include an audio output functionality corresponding to the audio event associated with the item of media content, a light output functionality corresponding to the lighting event associated with the item of media content, an image-output functionality corresponding to the image event, a video-output functionality corresponding to the pre-recorded video event, or a rendering functionality corresponding to the rendered video event and/or other functionality

In some aspects, the first event tag includes an indication of a first target device type associated with the first client device. One or more characteristics of the first event in the item of media content can include a volume of audio associated with the first event, an origination location of the audio associated with the first event, and/or other characteristic. In some examples, the first event tag corresponds to a time stamp within the item of media content.

In some examples, the server device (or component thereof) can transmit the plurality of event tags to a network device of the network. In one illustrative example, the server device (or component thereof) can transmit the plurality of event tags to the network device with the item of media content. In another illustrative example, the server device (or component thereof) can transmit the plurality of event tags to the network device in a file that is separate from the item of media content.

As noted previously, the process 700 and/or the process 800 may be performed by one or more computing devices or apparatuses. In some cases, such a computing device or apparatus may include a processor, microprocessor, microcomputer, or other component of a device that is configured to carry out the steps of the process 700 and/or the process 800. In some examples, such computing device or apparatus may include one or more sensors (e.g., one or more cameras, range sensors, microphones, etc.) configured to capture sensor data (e.g., image data, range sensor data, audio data, etc.). In some cases, the computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 and the process 800 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or the process 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 illustrates an example computing device architecture 900 of an example computing device which can implement various techniques described herein. For example, the computing device architecture 900 can implement at least some portions of the network device 102 of FIG. 1, the network device 502 of FIG. 5, the media server device 106 of FIG. 1, any one or more of the client devices 104-A through 104-N of FIG. 1, and/or other device described herein. The components of the computing device architecture 900 are shown in electrical communication with each other using a connection 905, such as a bus. The example computing device architecture 900 includes a processing unit (CPU or processor) 910 and a computing device connection 905 that couples various computing device components including the computing device memory 915, such as read only memory (ROM) 920 and random access memory (RAM) 925, to the processor 910.

The computing device architecture 900 can include a cache of high-speed memory connected directly with, in close proximity to, or integrated as part of the processor 910. The computing device architecture 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other computing device memory 915 may be available for use as well. The memory 915 can include multiple different types of memory with different performance characteristics.

The processor 910 can include any general purpose processor and a hardware or software service, such as service 1 932, service 2 934, and service 3 936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device architecture 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art, such as a display, projector, television, speaker device. In some instances, multimodal computing devices can enable a user to provide multiple types of input to communicate with the computing device architecture 900. The communication interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A. B. or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to.” or the like indicates that one processor or multiple processors (in any combination) can perform the associated operation(s). For example, claim language reciting “at least one processor configured to: X. Y, and Z” means a single processor can be used to perform operations X. Y, and Z; or that multiple processors are each tasked with a certain subset of operations X, Y, and Z such that together the multiple processors perform X, Y, and Z; or that a group of multiple processors work together to perform operations X. Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of enhancing media content performed by a network device of a network, the method comprising: detecting a first event tag in an item of media content, the first event tag being associated with a first event in the item of media content and a first functionality of a first client device connected to the network, the first functionality corresponding to the first event in the item of media content; and based on detecting the first event tag in the item of media content, transmitting a first activation message to the first client device to cause the first client device to perform the first functionality corresponding to the first event in the item of media content.

Aspect 2. The method of Aspect 1, further comprising: detecting a plurality of client devices connected to the network, the plurality of client devices including the first client device; determining a respective location of each client device of the plurality of client devices in an environment; generating configuration information for each client device of the plurality of client devices, the configuration information including one or more target device types and the respective location of each client device of the plurality of client devices; and storing the configuration information.

Aspect 3. The method of Aspect 2, further comprising: classifying the plurality of client devices into the one or more target device types.

Aspect 4. The method of any one of Aspects 2 or 3, wherein the first event tag includes an indication of a first target device type of the one or more target device types.

Aspect 5. The method of Aspect 4, wherein the first activation message is transmitted to the first client device further based on the indication of the first target device type in the first event tag.

Aspect 6. The method of any one of Aspects 1 to 5, further comprising: detecting a second event tag in the item of media content, the second event tag being associated with the first event in the item of media content and a second functionality of a second client device connected to the network, the second functionality of the second client device corresponding to the first event in the item of media content; and based on detecting the second event tag in the item of media content, transmit a second activation message to the second client device to cause the second client device to perform the second functionality corresponding to the first event in the item of media content.

Aspect 7. The method of any one of Aspects 1 to 5, further comprising: detecting a second event tag in the item of media content, the second event tag being associated with a second event in the item of media content and a second functionality of a second client device connected to the network, the second functionality of the second client device corresponding to the second event in the item of media content; and based on detecting the second event tag in the item of media content, transmit a second activation message to the second client device to cause the second client device to perform the second functionality corresponding to the second event in the item of media content.

Aspect 8. The method of Aspect 6 or 7, wherein the plurality of client devices connected to the network include the first client device and the second client device.

Aspect 9. The method of Aspect 8, wherein the second event tag includes an indication of a second target device type of the one or more target device types.

Aspect 10. The method of Aspect 9, further comprising: determining, based on the stored configuration information, that the second client device is classified as the second target device type; wherein the second activation message is transmitted to the second client device further based on the indication of the second target device type in the second event tag and determining that the second client device is classified as the second target device type.

Aspect 11. The method of any one of Aspects 1 to 10, wherein the first activation message is transmitted to the first client device further based on a location of the first client device in an environment and a characteristic of the first event in the item of media content.

Aspect 12. The method of Aspect 11, wherein the characteristic of the first event in the item of media content includes at least one of a volume of audio associated with the first event or an origination location of the audio associated with the first event.

Aspect 13. The method of any one of Aspects 1 to 12, wherein the first event tag corresponds to a time stamp within the item of media content.

Aspect 14. The method of any one of Aspects 1 to 13, wherein the first event in the item of media content includes at least one of an audio event in the item of media content or lighting associated with the item of media content.

Aspect 15. The method of Aspect 14, wherein the first functionality of the first client device includes an audio output functionality corresponding to the audio event in the item of media content or a light output functionality corresponding to the lighting of the item of media content.

Aspect 16. The method of any one of Aspects 1 to 15, wherein the item of media content is pre-recorded content.

Aspect 17. The method of any one of Aspects 1 to 16, wherein the item of media content is live content.

Aspect 18. A network device for enhancing media content, the network device comprising at least one memory and at least one processor coupled to the at least one memory, the at least one processor configured to perform operations according to any of methods 1 to 17.

Aspect 19. A non-transitory computer-readable medium having instructions that, when executed by at least one processor, cause the at least one processor to perform operations according to any of methods 1 to 17.

Aspect 20. An apparatus comprising one or more means for performing operations according to any of methods 1 to 17.

Aspect 21. A method of processing media content performed by a server device, the method comprising: obtaining an item of media content; processing the item of media content to identify a plurality of events in the item of media content; and generating a plurality of event tags for the plurality of events, the plurality of event tags including at least a first event tag associated with a first event in the item of media content and a first functionality of a first client device connected to a network.

Aspect 22. The method of Aspect 21, further comprising: transmitting the plurality of event tags to a network device of the network.

Aspect 23. The method of Aspect 22, wherein the plurality of event tags are transmitted to the network device with the item of media content.

Aspect 24. The method of Aspect 22, wherein the plurality of event tags are transmitted to the network device in a file that is separate from the item of media content.

Aspect 25. The method of any one of Aspects 21 to 24, wherein the first event tag includes an indication of a first target device type associated with the first client device.

Aspect 26. The method of any one of Aspects 21 to 25, wherein a characteristic of the first event in the item of media content includes at least one of a volume of audio associated with the first event or an origination location of the audio associated with the first event.

Aspect 27. The method of any one of Aspects 21 to 26, wherein the first event tag corresponds to a time stamp within the item of media content.

Aspect 28. The method of any one of Aspects 21 to 27, wherein the first event in the item of media content includes at least one of an audio event in the item of media content or lighting associated with the item of media content.

Aspect 29. The method of Aspect 28, wherein the first functionality of the first client device includes an audio output functionality corresponding to the audio event in the item of media content or a light output functionality corresponding to the lighting of the item of media content.

Aspect 30. The method of any one of Aspects 21 to 29, wherein the item of media content is pre-recorded content.

Aspect 31. The method of any one of Aspects 21 to 30, wherein the item of media content is live content.

Aspect 32. A server device for process media content, the server device comprising at least one memory and at least one processor coupled to the at least one memory, the at least one processor configured to perform operations according to any of methods 21 to 31.

Aspect 33. A non-transitory computer-readable medium having instructions that, when executed by at least one processor, cause the at least one processor to perform operations according to any of methods 21 to 31.

Aspect 34. An apparatus comprising one or more means for performing operations according to any of methods 21 to 31.

Aspect 35. A method of enhancing media content performed by a network device of a network, the method comprising: detecting a first event tag in an item of media content, the first event tag being associated with a first event in the item of media content and a first functionality of a first client device connected to the network, the first functionality corresponding to the first event in the item of media content; and based on detecting the first event tag in the item of media content, transmitting a first activation message to the first client device to cause the first client device to perform the first functionality corresponding to the first event in the item of media content.

Aspect 36. The method of aspect 35, further comprising: detecting a plurality of client devices connected to the network, the plurality of client devices including the first client device; determining a respective location of each client device of the plurality of client devices in an environment; generating configuration information for each client device of the plurality of client devices, the configuration information including one or more target device types and the respective location of each client device of the plurality of client devices; and storing the configuration information.

Aspect 37. The method of aspect 36, further comprising classifying the plurality of client devices into the one or more target device types; wherein the first event tag includes an indication of a first target device type of the one or more target device types; and wherein the first activation message is transmitted to the first client device further based on the indication of the first target device type in the first event tag.

Aspect 38. The method of any one of aspects 35 to 37, further comprising: detecting a second event tag in the item of media content, the second event tag being associated with the first event in the item of media content and a second functionality of a second client device connected to the network, the second functionality of the second client device corresponding to the first event in the item of media content; and based on detecting the second event tag in the item of media content, transmitting a second activation message to the second client device to cause the second client device to perform the second functionality corresponding to the first event in the item of media content.

Aspect 39. The method of any one of aspects 35 to 38, further comprising: detecting a second event tag in the item of media content, the second event tag being associated with a second event in the item of media content and a second functionality of a second client device connected to the network, the second functionality of the second client device corresponding to the second event in the item of media content; and based on detecting the second event tag in the item of media content, transmitting a second activation message to the second client device to cause the second client device to perform the second functionality corresponding to the second event in the item of media content.

Aspect 40. The method of any one of aspects 35 to 39, wherein the first activation message is transmitted to the first client device further based on a location of the first client device in an environment and a characteristic of the first event in the item of media content.

Aspect 41. The method of aspect 40, wherein the characteristic of the first event in the item of media content includes at least one of a volume of audio associated with the first event or an origination location of the audio associated with the first event.

Aspect 42. The method of any one of aspects 35 to 41, wherein the first event tag corresponds to a time stamp within the item of media content.

Aspect 43. The method of any one of aspects 35 to 42, wherein the first event in the item of media content includes at least one of: an audio event associated with the item of media content, a lighting event associated with the item of media content, an image event associated with the item of media content, a pre-recorded video event associated with the item of media content, or a rendered video event associated with the item of media content.

Aspect 44. The method of aspect 43, wherein the first functionality of the first client device includes at least one of: an audio output functionality corresponding to the audio event in the item of media content, a light output functionality corresponding to the lighting event associated with the item of media content, an image-output functionality corresponding to the image event, a video-output functionality corresponding to the pre-recorded video event, or a rendering functionality corresponding to the rendered video event.

Aspect 45. The method of any one of aspects 35 to 44, wherein the item of media content is pre-recorded content.

Aspect 46. The method of any one of aspects 35 to 45, wherein the item of media content is live content.

Aspect 47. A method of processing media content performed by a server device, the method comprising: obtaining an item of media content; processing the item of media content to identify a plurality of events in the item of media content; and generating a plurality of event tags for the plurality of events, the plurality of event tags including at least a first event tag associated with a first event in the item of media content and a first functionality of a first client device connected to a network.

Aspect 48. The method of aspect 47, further comprising: transmitting the plurality of event tags to a network device of the network.

Aspect 49. The method of any one of aspects 47 or 48, wherein the first event tag includes an indication of a first target device type associated with the first client device.

Aspect 50. The method of any one of aspects 47 to 49, wherein the first event tag corresponds to a time stamp within the item of media content.

Aspect 51. The method of any one of aspects 47 to 50, wherein the first event in the item of media content includes at least one of: an audio event associated with the item of media content, a lighting event associated with the item of media content, an image event associated with the item of media content, a pre-recorded video event associated with the item of media content, or a rendered video event associated with the item of media content.

Aspect 52. The method of aspect 51, wherein the first functionality of the first client device includes at least one of: an audio output functionality corresponding to the audio event in the item of media content, a light output functionality corresponding to the lighting event associated with the item of media content, an image-output functionality corresponding to the image event, a video-output functionality corresponding to the pre-recorded video event, or a rendering functionality corresponding to the rendered video event.

Aspect 53. The method of any one of aspects 47 to 52, wherein the item of media content is pre-recorded content.

Aspect 54. The method of any one of aspects 47 to 53, wherein the item of media content is live content.

Aspect 55. A non-transitory computer-readable storage medium having stored thereon instructions that, when executed by at least one processor, cause the at least one processor to perform operations according to any of aspects 1 to 17, 21 to 31, or 35 to 54.

Aspect 56. An apparatus for providing virtual content for display, the apparatus comprising one or more means for perform operations according to any of aspects 1 to 17, 21 to 31, or 35 to 54.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method of enhancing media content performed by a network device of a network, the method comprising:
detecting a first event tag in an item of media content, the first event tag being associated with a first event in the item of media content and a first functionality of a first client device connected to the network, the first functionality corresponding to the first event in the item of media content; and
based on detecting the first event tag in the item of media content, transmitting a first activation message to the first client device to cause the first client device to perform the first functionality corresponding to the first event in the item of media content.

2. The method of claim 1, further comprising:
detecting a plurality of client devices connected to the network, the plurality of client devices including the first client device;
determining a respective location of each client device of the plurality of client devices in an environment;
generating configuration information for each client device of the plurality of client devices, the configuration information including one or more target device types and the respective location of each client device of the plurality of client devices; and
storing the configuration information.

3. The method of claim 2, further comprising classifying the plurality of client devices into the one or more target device types;
wherein the first event tag includes an indication of a first target device type of the one or more target device types; and
wherein the first activation message is transmitted to the first client device further based on the indication of the first target device type in the first event tag.

4. The method of claim 1, further comprising:
detecting a second event tag in the item of media content, the second event tag being associated with the first event in the item of media content and a second functionality of a second client device connected to the network, the second functionality of the second client device corresponding to the first event in the item of media content; and
based on detecting the second event tag in the item of media content, transmitting a second activation message to the second client device to cause the second client device to perform the second functionality corresponding to the first event in the item of media content.

5. The method of claim 1, further comprising:
detecting a second event tag in the item of media content, the second event tag being associated with a second event in the item of media content and a second functionality of a second client device connected to the network, the second functionality of the second client device corresponding to the second event in the item of media content; and
based on detecting the second event tag in the item of media content, transmitting a second activation message to the second client device to cause the second client device to perform the second functionality corresponding to the second event in the item of media content.

6. The method of claim 1, wherein the first activation message is transmitted to the first client device further based on a location of the first client device in an environment and a characteristic of the first event in the item of media content.

7. The method of claim 6, wherein the characteristic of the first event in the item of media content includes at least one of a volume of audio associated with the first event or an origination location of the audio associated with the first event.

8. The method of claim 1, wherein the first event tag corresponds to a time stamp within the item of media content.

9. The method of claim 1, wherein the first event in the item of media content includes at least one of:
an audio event associated with the item of media content,
a lighting event associated with the item of media content,
an image event associated with the item of media content,
a pre-recorded video event associated with the item of media content, or
a rendered video event associated with the item of media content.

10. The method of claim 9, wherein the first functionality of the first client device includes at least one of:
an audio output functionality corresponding to the audio event in the item of media content,
a light output functionality corresponding to the lighting event associated with the item of media content,
an image-output functionality corresponding to the image event,
a video-output functionality corresponding to the pre-recorded video event, or
a rendering functionality corresponding to the rendered video event.

11. The method of claim 1, wherein the item of media content is pre-recorded content.

12. The method of claim 1, wherein the item of media content is live content.

13. A method of processing media content performed by a server device, the method comprising:
obtaining an item of media content;
processing the item of media content to identify a plurality of events in the item of media content; and
generating a plurality of event tags for the plurality of events, the plurality of event tags including at least a first event tag associated with a first event in the item of media content and a first functionality of a first client device connected to a network.

14. The method of claim 13, further comprising:
transmitting the plurality of event tags to a network device of the network.

15. The method of claim 13, wherein the first event tag includes an indication of a first target device type associated with the first client device.

16. The method of claim 13, wherein the first event tag corresponds to a time stamp within the item of media content.

17. The method of claim 13, wherein the first event in the item of media content includes at least one of:
an audio event associated with the item of media content,
a lighting event associated with the item of media content,
an image event associated with the item of media content,
a pre-recorded video event associated with the item of media content, or
a rendered video event associated with the item of media content.

18. The method of claim 17, wherein the first functionality of the first client device includes at least one of:
an audio output functionality corresponding to the audio event in the item of media content,
a light output functionality corresponding to the lighting event associated with the item of media content,
an image-output functionality corresponding to the image event,
a video-output functionality corresponding to the pre-recorded video event, or
a rendering functionality corresponding to the rendered video event.

19. The method of claim 13, wherein the item of media content is pre-recorded content.

20. The method of claim 13, wherein the item of media content is live content.
